(19) United States
(12) Patent Application Publication
(10) Pub. No.: US 2015/0122173 A1
(43) Pub. Date: May 7, 2015

(54) CROSSMEMBER DEVICE, FLOOR UNIT AND COATING AND/OR PROCESSING INSTALLATION

(71) Applicant: Dürr Systems GmbH, Bietigheim-Bissingen (DE)

(72) Inventors: Andreas Federmann, Stuttgart (DE); Mario Reiber, Sachsenheim (DE); Michael Baitinger, Marbach (DE); Samuel Caspari, Marienheide (DE)

(21) Appl. No.: 14/397,812

(22) PCT Filed: Apr. 26, 2013
(86) PCT No.: PCT/EP2013/058717

§ 371 Date: Oct. 29, 2014

(30) Foreign Application Priority Data
May 3, 2012 (DE) 10 2012 207 389.2

(51) Int. Cl. B05B 15/12; B05B 13/02; B65G 39/12

(52) U.S. Cl. CPC B05B 15/1288; B65G 39/12; B05B 13/0221
USPC 118/500; 198/860.3; 198/339.1

(57) ABSTRACT

In order to provide a crossmember device for a floor unit of a coating and/or processing chamber where components of a drive device for a conveying device are protected from unwanted contamination, it is proposed that the crossmember device includes a crossmember and a force-transmitting drive element of a drive device, wherein the drive element is arranged at least in portions in an interior of the crossmember.

The present invention relates to a crossmember device for a floor unit of a coating and/or processing chamber.

A coating and/or processing chamber can be, for example, a spray booth of a paint facility. A floor unit of the paint facility is then preferably air-permeable such that paint overspray which is generated when paint is applied to workpieces is able to be extracted through the floor unit. In this connection, the floor unit and all the components mounted on the floor unit can be impinged upon in an undesired manner with paint overspray. For example, the operation and reliability of a conveying device for conveying workpieces can be impaired as a result.

The object underlying the present invention is to provide a crossmember device for a floor unit of a coating and/or processing chamber, by means of which components of a drive device for a conveying device are able to be protected from unwanted contaminants.

Said object is achieved according to the invention by a crossmember device for a floor unit of a coating and/or processing chamber which includes the following:
a crossmember which comprises an interior;
a force-transmitting drive element of a drive device for driving a load-bearing roller of a conveying device for conveying workpieces,
   wherein the drive element is arranged at least in portions in the interior of the crossmember.

By the drive element in the case of the crossmember device according to the invention being arranged at least in portions in the interior of the crossmember, the drive element of the drive device is protected from unwanted contaminants.

The term crossmember in said description and in the accompanying claims refers in particular to a load-bearing element of a floor unit which, when mounted in a coating and/or processing installation, extends transversely, in particular substantially perpendicularly, with respect to a longitudinal direction of the coating and/or processing installation and/or with respect to a conveying direction of the conveying device.

The drive element is preferably arranged substantially completely in the interior of the crossmember. In this way, the drive element is protected particularly well from unwanted contaminants.

The drive element is preferably incorporated in the crossmember.

It can be favorable when the crossmember forms an enclosure for at least one portion of the force-transmitting drive element. The crossmember surrounds the drive element preferably at least in portions at least on three sides.

The crossmember device is suitable, in particular, for use in an air-permeable floor unit of a coating and/or processing chamber. In particular, the crossmember device is suitable for use in floor unit through which air extraction is possible.

The term a force-transmitting drive element is to be understood, in particular, in said description and the accompanying claims as a torque-transmitting drive element. For example, it can be provided that the force-transmitting drive element transmits a rotational movement.

Processing in terms of the present invention and the accompanying claims is, in particular, machining of a workpiece.

In the case of a development of the invention, it is provided that the crossmember device includes a load-bearing roller receiving means for a load-bearing roller of the conveying device.

The load-bearing roller receiving means is preferably arranged on the crossmember, in particular is incorporated in the crossmember.

The load-bearing roller receiving means is preferably arranged at least in portions, preferably substantially completely, in the interior of the crossmember.

The load-bearing roller is preferably rotatably mounted by means of the load-bearing roller receiving means.

It can be favorable when the crossmember comprises at least two crossmember portions which are arranged one behind another with reference to a longitudinal direction of the crossmember and are arranged offset with respect to one another in a transverse direction of the crossmember which extends transversely, in particular substantially perpendicularly with respect to the longitudinal direction.

With the crossmember device in the mounted state, the longitudinal direction of the crossmember is, in particular, a transverse direction of the coating and/or processing installation, in particular of the coating and/or processing chamber.

A transverse direction of the crossmember is a direction which extends transversely, in particular substantially perpendicularly, with respect to the longitudinal direction. For example, the transverse direction, with the crossmember device in the mounted state, is a vertical or horizontal direction.

It can be favorable when the crossmember comprises a crossmember portion which is offset in the vertical direction toward the coating and/or processing region or away from the coating and/or processing region.

The longitudinal direction of the crossmember is preferably the main direction of extension of the crossmember, i.e. the direction in which the crossmember comprises the longest dimension in the mounted state.

The longitudinal direction of the crossmember is preferably the longitudinal direction of the coating and/or processing chamber and/or the conveying direction of the conveying device.

The crossmember comprises preferably a crossmember portion which extends transversely with respect to a longitudinal direction of the crossmember. It can be provided, in particular, that the crossmember comprises a crossmember portion which extends substantially perpendicularly with respect to a longitudinal direction of the crossmember.

In the case of a development of the invention, it is provided that the crossmember includes two crossmember portions which extend transversely with respect to a longitudinal direction of the crossmember and one crossmember portion which is arranged offset with reference to a transverse direction which extends perpendicularly with respect to the longitudinal direction, extends parallel to the longitudinal direction and is arranged between the two crossmember portions which extend transversely with respect to the longitudinal direction of the crossmember. In this way, a crossmember portion is formed in particular which is arranged offset laterally from a direct connecting line between two connecting points of the crossmember at the end of the crossmember.

At least one crossmember portion of the crossmember preferably lies next to a direct connecting line between the connecting points of the crossmember at the ends of the crossmember.

The term a crossmember portion is to be understood, in particular, as a portion of the crossmember, along which forces are transmitted between the ends of the crossmember. A crossmember portion is consequently in particular a portion of a load path of the crossmember.

The crossmember preferably comprises a substantially U-shaped structure. The crossmember portion includes for this purpose preferably two crossmember portions which extend transversely, in particular substantially perpendicularly, with respect to the longitudinal direction and one crossmember portion which extends preferably substantially parallel to the longitudinal direction and is arranged between the crossmember portions which extend transversely with respect to the longitudinal direction.

The substantially U-shaped structure of the crossmember preferably points downward in the substantially vertical direction or upward in the substantially vertical direction.

In the case of a development of the invention, it is provided that the crossmember device includes a load-bearing roller of the conveying device and a coupling device for coupling the load-bearing roller with the drive element.

The coupling device can include, for example, a toothed belt and/or a chain.

A force, a torque and/or a rotational movement can be transmitted from the drive element to the load-bearing roller by means of the coupling device.

It can be favorable when the crossmember device includes a shaft for two or more load-bearing rollers.

It can be advantageous when the crossmember device includes a load-bearing roller of the conveying device, wherein a rotational axis of the load-bearing roller is arranged offset in relation to a rotational axis of the drive element in a transverse direction of the crossmember which extends transversely, in particular substantially perpendicular, with respect to a longitudinal direction of the crossmember.

It can be provided, in particular, that a rotational axis of the load-bearing roller and a rotational axis of the drive element extend substantially parallel to one another.

The crossmember device preferably includes at least two load-bearing rollers and/or at least two force-transmitting drive elements which are arranged at least in portions in the interior of the crossmember.

It can be favorable when the crossmember device includes a bearing device for the rotatable bearing arrangement of the force-transmitting drive element.

The bearing device is preferably arranged at least in part, in particular substantially completely, in the interior of the crossmember. It can be provided, in particular, that the bearing device is incorporated at least in part, in particular substantially completely, in the crossmember.

The drive element can be realized, for example, as a shaft. It can be provided, in particular, that the drive element is realized as a Cardan shaft.

The crossmember device preferably includes a pair of load-bearing rollers, wherein one or both of the load-bearing rollers of the pair of load-bearing rollers are connected to the drive element for driving the same.

For example, it can be provided that a pair of load-bearing rollers is provided, the two load-bearing rollers being arranged so as to rotate independently of one another. In particular, it can be provided that the two load-bearing rollers of the pair of load-bearing rollers are drivable independently of one another. Each load-bearing roller of the two load-bearing rollers can be connected to a different drive element for this purpose.

In the case of a development of the invention, it is provided that the crossmember device includes a pair of load-bearing rollers, wherein the two load-bearing rollers of the pair of load-bearing rollers are connected non-rotatably together by means of a common shaft. The pair of load-bearing rollers can be driven in a particularly simple manner in this way as a result of coupling the shaft with the drive element.

The crossmember device according to the invention is suitable, in particular, for use in a floor unit for a coating and/or processing chamber.

The present invention additionally relates to a floor unit of a coating and/or processing chamber, in particular of a coating and/or processing installation.

The object underlying the invention in this respect is to provide a floor unit by means of which components of a drive device for a conveying device can be protected from unwanted contaminants.

Said object is achieved according to the invention in that a floor unit for a coating and/or processing chamber, in particular for a coating and/or processing installation, includes at least one crossmember device according to the invention.

The floor unit preferably includes a load-bearing structure which includes several crossmembers which are preferably aligned substantially parallel to one another, at least one crossmember being a crossmember of a crossmember device according to the invention.

The floor unit preferably includes two or more crossmembers and/or one, two or more longitudinal members on which the crossmembers are arranged.

The floor unit preferably includes two longitudinal members on which the crossmembers are arranged and between which the crossmembers extend.

In the case of a development of the invention, it is provided that the floor unit includes a crossmember device and in addition a crossmember on which a load-bearing roller of the conveying device is arranged, wherein the load-bearing roller is drivable by means of the drive element of the crossmember device.

The load-bearing roller of the additional crossmember is connected to the drive element of the crossmember device preferably by means of a coupling element of a coupling device, in particular by means of a toothed belt or a chain.

In addition, it can be provided that the floor unit includes a crossmember device and in addition a load-bearing roller which is spaced apart from the crossmember of the crossmember device and is drivable by means of the drive element of the crossmember device. The load-bearing roller is connected for this purpose to the drive element of the crossmember device, in particular by means of a coupling element, for example a toothed belt or a chain, of a coupling device.

The floor unit according to the invention is suitable in particular for use in a coating and/or processing installation for coating and/or processing, in particular for painting and/or machining, workpieces.

The present invention additionally relates to a coating and/or processing installation for coating and/or processing, in particular for painting and/or machining, workpieces.

The object underlying the invention in this respect is to provide a coating and/or processing installation for coating and/or processing workpieces, where components of a drive device for a conveying device can be protected from unwanted contaminants.

Said object is achieved according to the invention in that a coating and/or processing installation for coating and/or processing, in particular for painting and/or machining, workpieces includes the following:
a conveying device for conveying the workpieces through a coating and/or processing region of the coating and/or processing installation by means of workpiece carriers along a conveying direction of the conveying device, wherein the conveying device includes a load-bearing roller on which a workpiece carrier can be arranged for conveying the same;
a drive device for driving the load-bearing roller of the conveying device, wherein the drive device includes a force-transmitting drive element,
   wherein the force-transmitting drive element is arranged at least in portions in an interior of a crossmember of a floor unit of the coating and/or processing installation.

As a result of the force-transmitting drive element being arranged at least in portions in an interior of a crossmember in the case of the coating and/or processing installation according to the invention, it is protected from unwanted contaminants.

A coating and/or processing installation is in particular a paint facility for painting workpieces, vehicle bodies or parts of vehicles bodies.

It can be provided, in particular, that a coating and/or processing installation is a spray coating facility.

The coating and/or processing installation according to the invention preferably comprises at least one floor unit according to the invention and/or at least one crossmember device according to the invention.

The crossmember device according to the invention preferably comprises individual or several features and/or advantages of the floor unit according to the invention and/or of the coating and/or processing installation according to the invention.

The floor unit according to the invention preferably comprises individual or several features and/or advantages of the crossmember device according to the invention and/or of the coating and/or processing installation according to the invention.

The coating and/or processing installation according to the invention preferably comprises individual or several features and/or advantages of the crossmember device according to the invention and/or of the floor unit according to the invention.

The conveying device can be, in particular, a roller conveying device or roller conveyor.

A workpiece carrier can be, for example, a skid frame. In addition, it can be provided that the workpieces are receivable and conveyable in the conveying direction by means of skid runners which are connected together by the workpiece and/or one or several connecting elements.

A crossmember device is preferably a prefabricated or pre-mounted component which preferably forms an operational unit which is completed per se.

It can be advantageous when the conveying device for conveying workpieces through the coating and/or processing region includes several pairs of load-bearing roller receiving means which follow one another in the conveying direction for receiving, in each case, one pair of load-bearing rollers onto which the workpiece carriers, on which the workpieces can be arranged, can be placed in the mounted state of the coating and/or processing installation.

Individual load-bearing rollers or pairs of load-bearing rollers are preferably drivable by means of the drive device in order to convey the workpiece carriers, together with the workpieces arranged thereon, in the conveying direction.

The crossmember device according to the invention, the floor unit according to the invention and/or the coating and/or processing installation according to the invention can preferably additionally comprise individual or several of the features and/or advantages provided below:

the conveying device, in particular a roller conveyor, can preferably be constructed and mounted as a pre-mounted and/or prefabricated unit, in particular as a pre-mounted and/or prefabricated module.

The number of necessary shaft openings is preferably reduced.

It can be advantageous when it is possible to incorporate a grating.

The conveying device can comprise a connecting section, buffer section and/or storage section.

A coating and/or processing chamber is, in particular, an interior of a spray booth. In addition, it can be provided that a coating and/or processing chamber is a chamber in which a workstation, in particular for machining workpieces, is provided.

Where interfaces between adjacent conveying devices of an overall installation are coordinated, the expenditure and consequently also the risk of faults and resultant costs are preferably reduced.

The number of surfaces which can be wetted with overspray is preferably reduced.

External drives and shafts, in particular Cardan shafts, are preferably incorporated.

A roller conveyor conveying device is preferably incorporated in a steel construction below the coating and/or processing chamber.

Wet paints (solvent-containing and water-soluble paints), solvent-free coating materials (PVC plastisoles, waxes), powdered paints, sintered powders and/or metal powders can be applied, for example, in the coating and/or processing chamber. In addition, abrasive dust which is generated during repairs can occur in the coating and/or processing chamber.

A paint mist and overspray can be deposited, for example, with: wet scrubbing (washers), dry separation (filters) and filters and/or water cooling units (dust binding) which are precoated with precoat material (filter aids).

The floor unit, in particular a steel construction of the floor unit, is preferably supported below on load-bearing members, in particular so as to be vibration-free, and/or is fastened at a ceiling edge of a working plane.

For example, it can be provided that the floor unit, in particular a steel construction of the floor unit, includes two longitudinal members which preferably extend to the left and the right below the coating and/or processing chamber (spray booth). The longitudinal members preferably serve for receiving the application technology, for example for receiving robots, and/or for receiving connecting pieces of the coating and/or processing chamber, in particular of the spray booth, for receiving walls (lateral walls) of the coating and/or processing chamber and/or for receiving a plenum.

The floor unit, in particular a steel construction of the floor unit, preferably includes in addition crossmembers for receiving the conveying technology, in particular the conveying device.

The crossmembers are preferably arranged in a regular grid.

The crossmember device and/or the floor unit is preferably a prefabricated and/or pre-mounted module, the individual parts of which are able to be transported as connected pieces which are as large as possible to a site for the assembly of the coating and/or processing installation.

Different variants of roller conveyors can be used depending on the requirement.

For example, it can be provided that the conveying device includes driven load-bearing rollers (rollers) on one side.

It can be favorable when the conveying device includes two roller conveyors which extend parallel to one another, in each case only one, for example a left or a right roller conveyor with reference to the conveying direction, or both roller conveyors being driven.

In addition, it can be provided that the conveying device includes free-wheeling load-bearing rollers.

In addition, all conceivable combinations of driven and free-wheeling rollers can be provided.

The conveying device, in particular the roller conveyor, is preferably adapted to the design of the floor unit, in particular to the steel construction of the floor unit. Separate crossmembers for the conveying device are preferably unnecessary.

The dimension and overall height of one or several crossmembers is preferably adapted with consideration to the height of the roller conveyor and/or skid and is directed in particular to the requirements of the application technology and to the materials handling connection as well as to the necessary height of a subsequent drier device.

The crossmember device and/or the floor unit is preferably an integrated booth module (IKM) or an integrated crossmember module (ITM).

The conveying device preferably comprises a load-bearing roller covering and/or runner covering, in particular skid runner covering, which is continuous in the conveying direction.

The covering is preferably placed in position from above in the vertical direction and can consequently easily be removed for cleaning purposes. The covering can be realized in two parts, for example, an upper covering extending above a skid runner and a lower covering extending below a skid runner, for example to prevent contamination of the load-bearing rollers.

The lower covering preferably comprises a beading or indentation which is arranged, in particular, on its horizontal end point and prevents contaminants, in particular liquid contaminants, passing into an interior of the covering, in particular running under the covering.

It can be favorable when only one load-bearing roller is driven by means of a drive element, in particular a Cardan shaft, via a coupling element, in particular a toothed belt or a chain, and the opposite load-bearing roller of the pair of load-bearing rollers is connected to the driven roller in a rigid manner by means of a shaft.

In addition, it can be provided that a shaft part, which is supported by two bearings, is driven inside the crossmember by the drive element, in particular by the Cardan shaft. A roller, which is arranged inside the crossmember and is placed in position such that an upper part segment projects out of the crossmember, preferably sits on the shaft part.

It can be favorable when two shaft parts, which are supported by two bearings, are driven inside the crossmember by means of the drive element, in particular the Cardan shaft. In particular, in each case a driven roller, which is placed in position inside the crossmember such that an upper part segment projects in each case out of the crossmember, preferably sits on the shaft parts.

For the case where it is necessary for the conveying device, in particular the roller conveyor, to be positioned particularly high, a distance element (spacer) can be arranged below a load-bearing roller receiving means, in particular below a roller housing, in particular can be screw-connected to the crossmember together with the load-bearing roller receiving means. The load-bearing roller in the load-bearing roller receiving means is preferably driven by way of a correspondingly longer coupling element, in particular a toothed belt or a chain, or is non-driven (free-wheeling).

In addition, it can be provided that the crossmember is cranked upward. The load-bearing rollers are then preferably also arranged on the cranked portion and in particular only one load-bearing roller from one side is driven by a drive element, in particular a Cardan shaft, and a coupling element. The coupling element, in this case, preferably extends inside a crossmember portion which extends transversely, in particular substantially perpendicularly, with respect to the longitudinal direction of the crossmember.

It can be favorable when the load-bearing rollers are arranged inside a cranked horizontal crossmember portion and are incorporated in the same. Of the load-bearing rollers supported by the bearings then either only one or both are driven, for example by means of a shaft connection and/or by means of a coupling element, in particular a toothed belt or a chain which is arranged inside the crossmember portion which extends transversely, in particular substantially perpendicularly, with respect to the longitudinal direction of the crossmember.

As an alternative to this or in addition to it, it can be provided that a crossmember is cranked downward. The arrangement and the drive of the load-bearing rollers is preferably effected substantially as has been described above with regard to a crossmember which is cranked upward.

It can be provided that the crossmember device comprises a support structure, by means of which two load-bearing rollers, which are connected rigidly to a shaft, are held. A coupling element for coupling the shaft to the drive element, in particular a Cardan shaft, preferably extends inside the support structure.

It can also be provided that load-bearing rollers are only held by a bearing block and do not comprise a roller housing. In this case, almost all parts are exposed, the coupling device, in particular a coupling element of the coupling device, preferably being covered.

A drive train is preferably incorporated into a structural steel booth construction.

A continuous conveying device, in particular a continuous roller conveyor conveying device, is preferably provided which, proceeding from a coating and/or processing installation, in particular a spray booth, extends over a drier, workstations and/or a connecting conveying technology. This can be realized in particular by using interchangeable modules.

As a result of using a roller conveyor conveying device, the workpieces are able to be integrated into the overall production sequence of a coating and/or processing installation, in particular of a paint facility, in a more flexible manner than compared to a load-bearing chain conveyor.

Different pulse times can preferably be realized inside the coating and/or processing chamber.

It can be favorable when at least one function of the coating and/or processing installation can be carried out, in particular can be controlled and/or regulated, by means of a control device.

It can be advantageous when the crossmember device, the floor unit and/or the coating and/or processing installation, in particular a conveying device of the coating and/or processing installation, includes a positioning device for positioning a workpiece carrier along with one or several workpieces arranged thereon.

The positioning device preferably includes a pushing device and/or a blocking device.

The pushing device includes, for example, a pressure cylinder device, in particular a hydraulic and/or pneumatic pressure cylinder device.

It can be favorable when the pushing device includes a lever element which is able to project into a conveying path of the workpiece carrier in order to be moved into engagement with the workpiece carrier.

The workpiece carrier along with the one or the several workpieces arranged thereon can preferably be moved by means of the pushing device, in particular in a direction opposite the conveying direction.

It can be provided that a piston rod of the pressure cylinder device of the pushing device can be pushed out or pressed out of a pressure cylinder of the pressure cylinder device in order to move the lever element of the pushing device into engagement with the workpiece carrier, in particular in order to move the workpiece carrier against the conveying direction.

In the case of a development of the invention, it can be provided that the blocking device includes a blocking element.

The blocking element preferably projects as an option into a conveying path of the workpiece carrier.

The blocking element is preferably resiliently mounted such that it is yielding in one direction of movement.

It can be advantageous when the blocking device is realized so as to be blocking in one direction.

The blocking device is preferably blocking in one direction in such a manner that the workpiece carrier along with the one or the several workpieces arranged thereon is able to be moved past the blocking device in the conveying direction, however a movement of the workpiece carrier along with the one or the several workpieces arranged thereon in a direction opposite the conveying direction is able to be blocked.

The blocking element can be realized, for example, as a locking pawl, which in particular in a spring-loaded manner, is able to be pushed into the conveying path of the workpiece carrier.

It can be provided that the pushing device and/or the blocking device is arranged at least in portions or completely inside and/or below a covering device for covering supporting elements of the workpiece carrier.

A covering device is, in particular, a runner covering for covering runners of a workpiece carrier which is realized as a skid.

The pushing device and/or the blocking device can be, for example, an accelerating device for accelerating the workpiece carrier and/or a braking device for braking the workpiece carrier.

For positioning the workpiece carrier along with the one or the several workpieces arranged thereon by means of a positioning device, the workpiece carrier along with the one or the several workpieces arranged thereon is preferably moved past the blocking device in the conveying direction.

In addition, the workpiece carrier along with the one or the several workpieces arranged thereon is moved in particular by means of the pushing device in a direction opposite the conveying direction.

It can be favorable when the workpiece carrier along with the one or the several workpieces arranged thereon is finally clamped between the blocking device and the pushing device.

Precise positioning of a workpiece carrier is important in particular for a painting operation as the painting robots have fixed reference points. The fixed reference points are established by way of a reference body for each body type. Correct positioning is important in particular because each deviation in the positioning can result in deviations in the painting result and in the paint consumption when the installation is operational, that is during the painting operation.

The positioning device is preferably incorporated in part or completely in a covering device, in particular in a runner covering. Contamination of the positioning device, in particular as a result of paint overspray, and the cleaning requirement of the positioning device can preferably be reduced as a result.

The positioning device can preferably be secured in a variable manner in relation to the conveying device, in particular in relation to a roller conveyor device of the conveying device. The position, at which the workpiece carrier along with the one or the several workpieces arranged thereon can be stopped by means of the positioning device, can preferably be modified even once the conveying device has been completed.

Further preferred features and/or advantages of the invention are the object of the following description and of the graphic representation of exemplary embodiments.

The drawings are as follows:

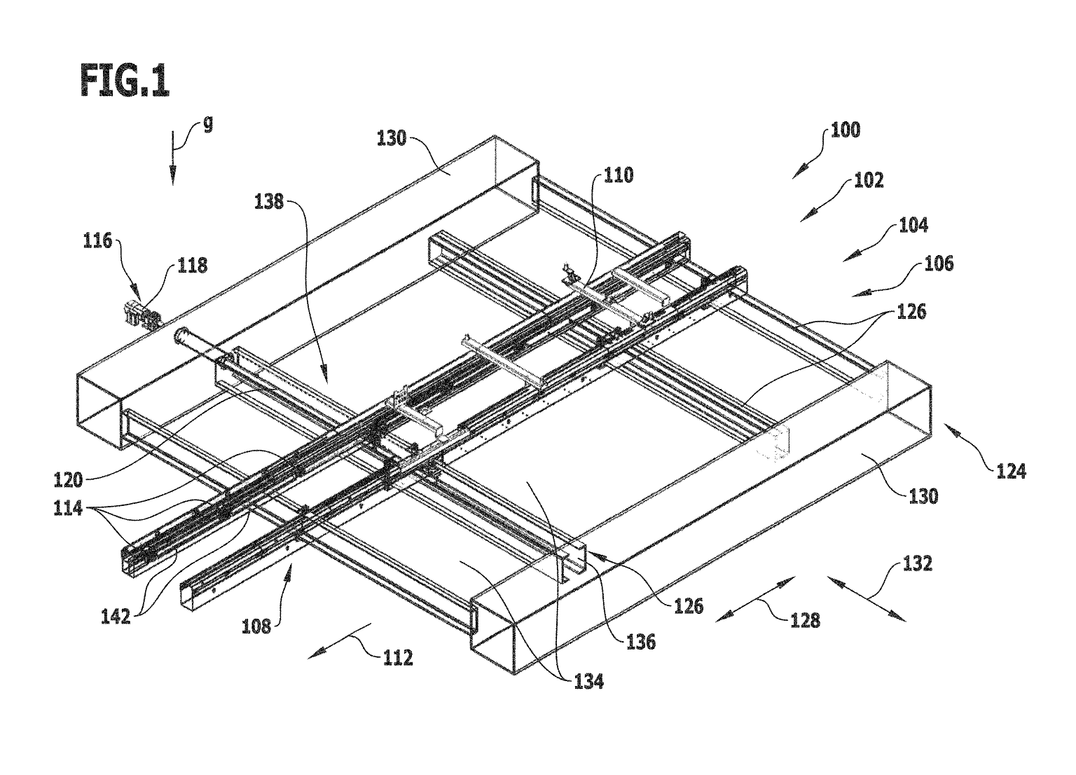

FIG. 1 shows a schematic perspective representation of a floor unit of a coating and/or processing installation;

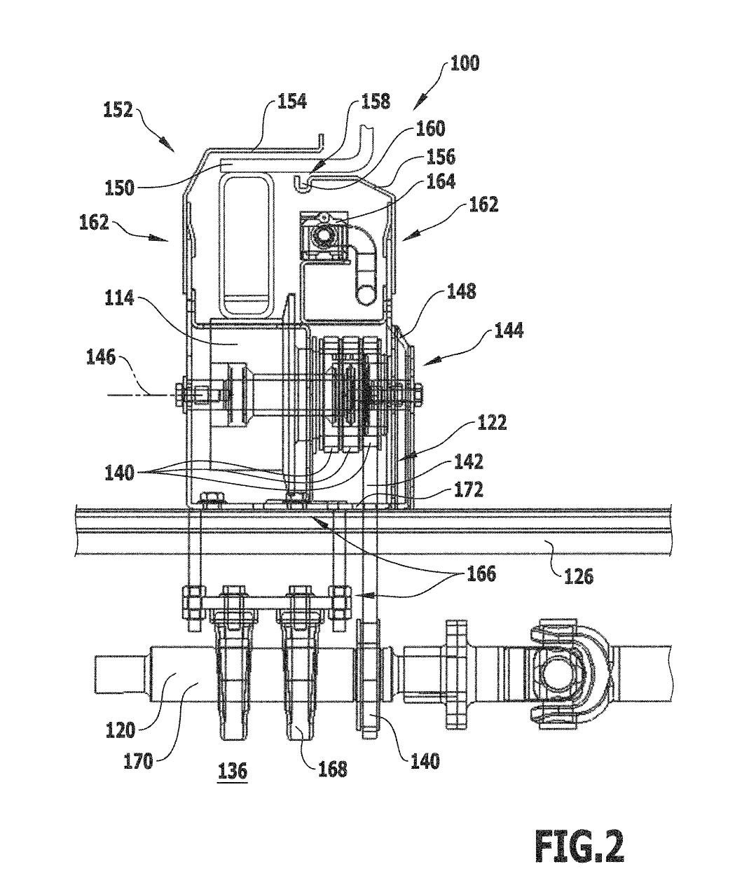

FIG. 2 shows a schematic vertical section through a portion of a crossmember device of the floor unit from FIG. 1 in which a load-bearing roller of a conveying device is arranged;

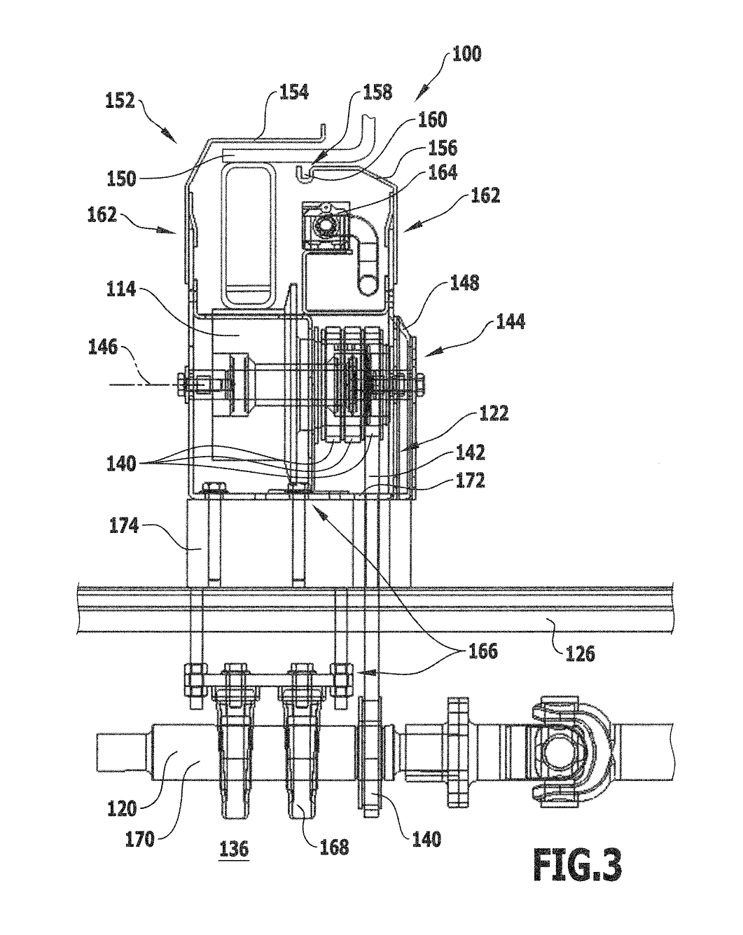

FIG. 3 shows a schematic sectional representation corresponding to FIG. 2 of a second embodiment of a crossmember device;

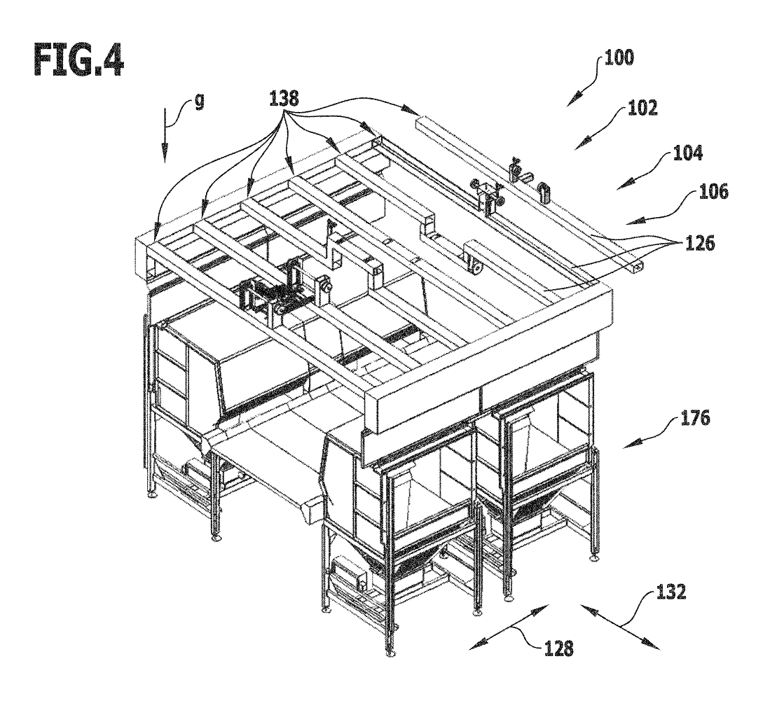

FIG. 4 shows a schematic perspective representation of a filter device of a coating and/or processing installation with seven different embodiments of crossmember devices;

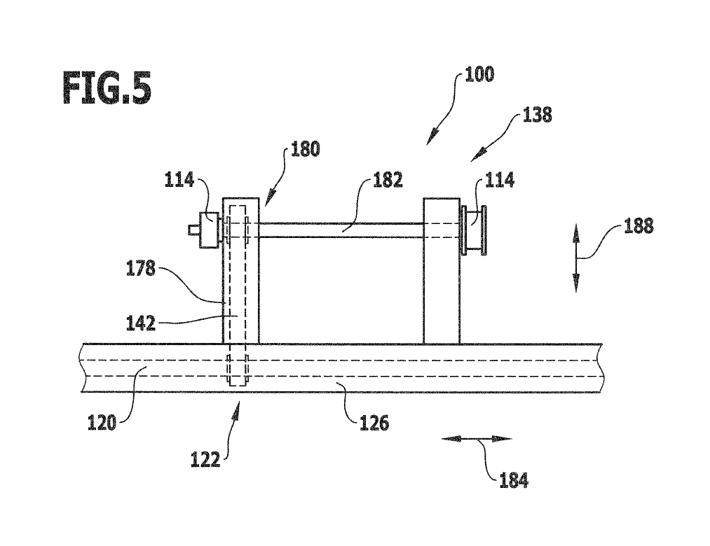

FIG. 5 shows a schematic representation of a third embodiment of a crossmember device where two load-bearing rollers of the conveying device are connected to a drive element of a drive device of the conveying device by means of a common shaft;

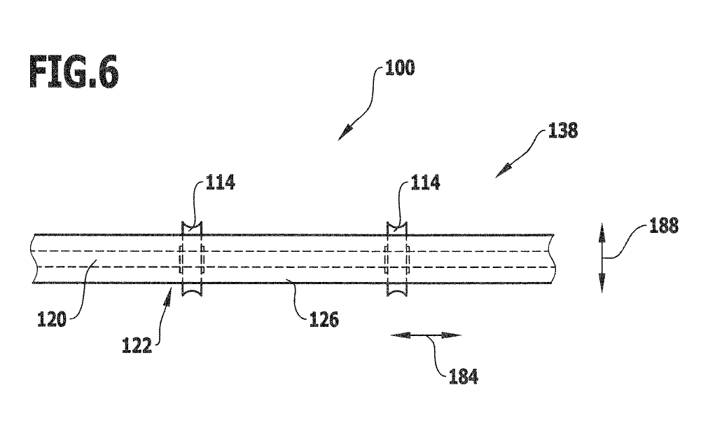

FIG. 6 shows a schematic representation corresponding to FIG. 5 of a fourth embodiment of a crossmember device where two load-bearing rollers of the conveying device are incorporated into a substantially linear crossmember, both load-bearing rollers being driven by means of a common drive element;

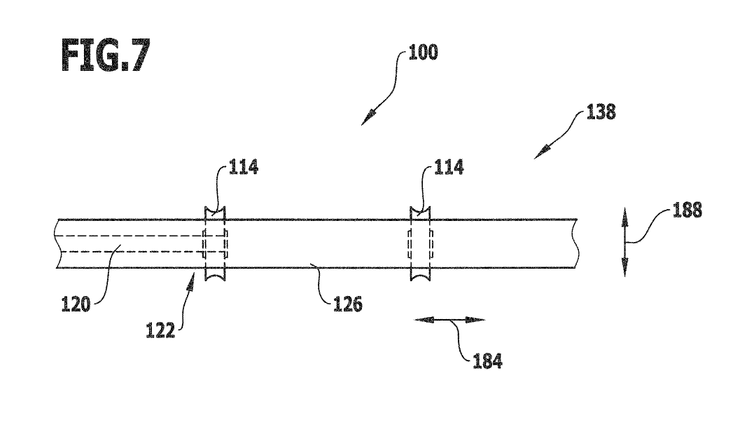

FIG. 7 shows a schematic representation corresponding to FIG. 5 of a fifth embodiment of a crossmember device where two load-bearing rollers of the conveying device are incorporated into a substantially linear crossmember, just one load-bearing roller being driven by means of a drive element;

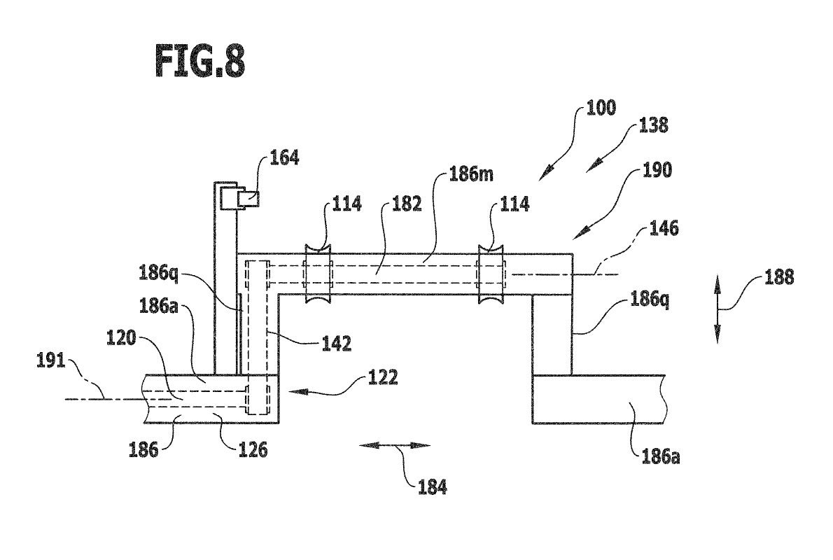

FIG. 8 shows a schematic representation corresponding to FIG. 5 of a sixth embodiment of a crossmember device where one crossmember portion which is offset upward in the vertical direction is provided in which two driven load-bearing rollers are incorporated;

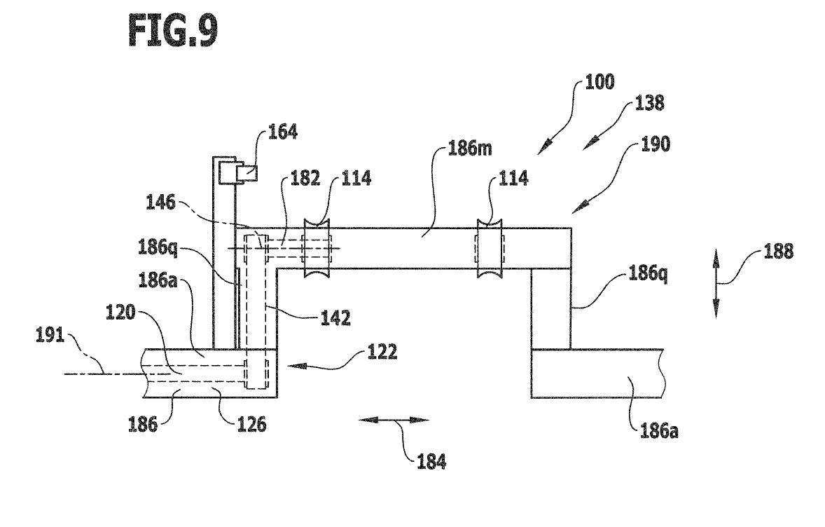

FIG. 9 shows a schematic representation corresponding to FIG. 5 of a seventh embodiment of a crossmember device which corresponds substantially to the sixth embodiment shown in FIG. 8, just one load-bearing roller being driven;

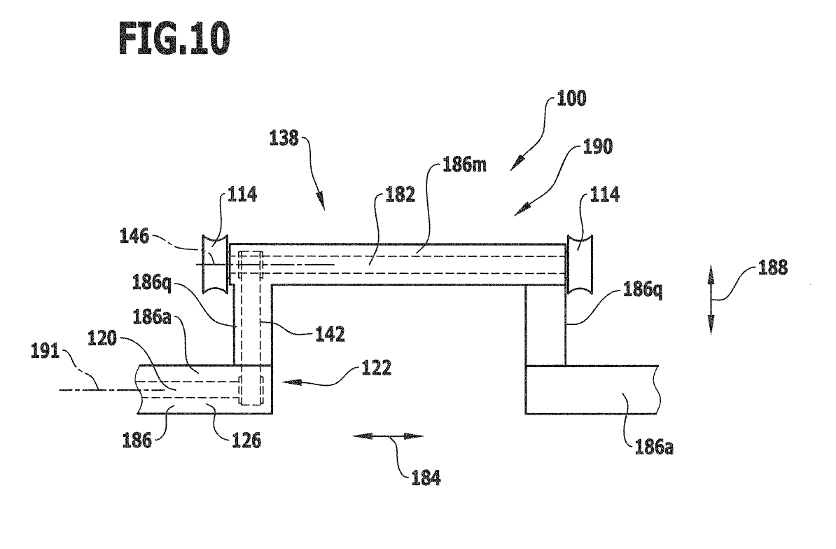

FIG. 10 shows a schematic representation corresponding to FIG. 5 of an eighth embodiment of a crossmember device where one crossmember portion which is offset upward in the vertical direction is provided, two driven load-bearing rollers which jut out laterally beyond the crossmember portion being provided;

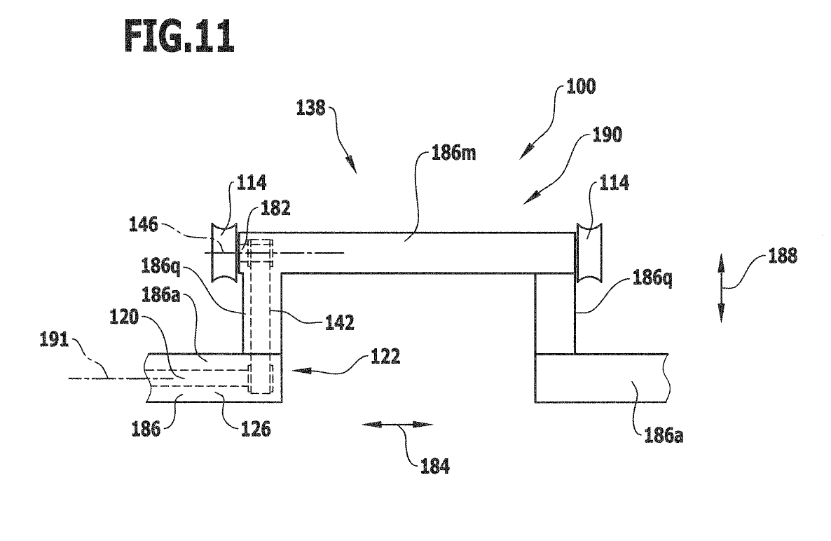

FIG. 11 shows a schematic representation corresponding to FIG. 5 of ninth embodiment of a crossmember device which corresponds substantially to the eighth embodiment shown in FIG. 10, just one load-bearing roller being driven;

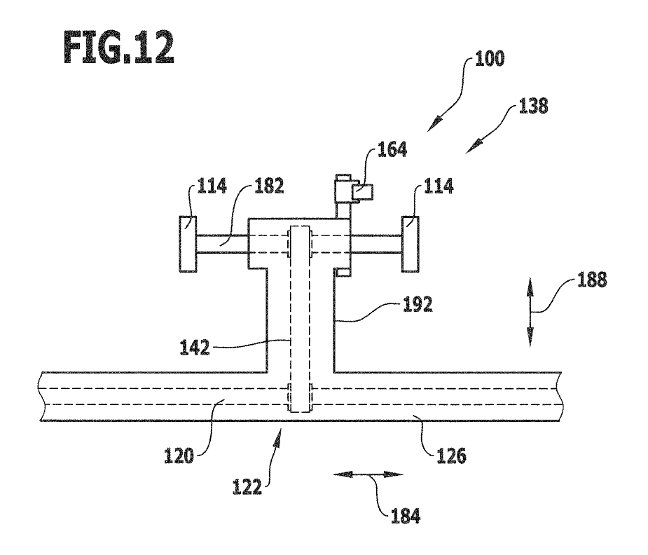

FIG. 12 shows a schematic representation corresponding to FIG. 5 of a tenth embodiment of a crossmember device where a supporting device is provided for receiving two load-bearing rollers which are arranged on common shaft;

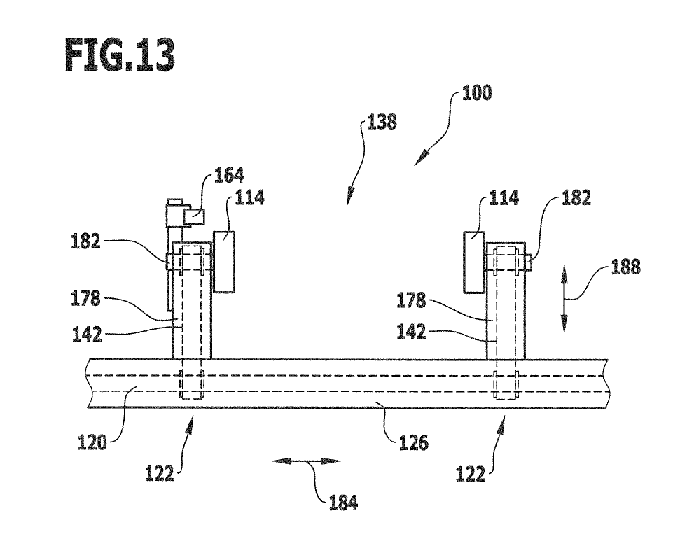

FIG. 13 shows a schematic representation corresponding to FIG. 5 of an eleventh embodiment of a crossmember device where two supporting devices are provided in each case for one load-bearing roller;

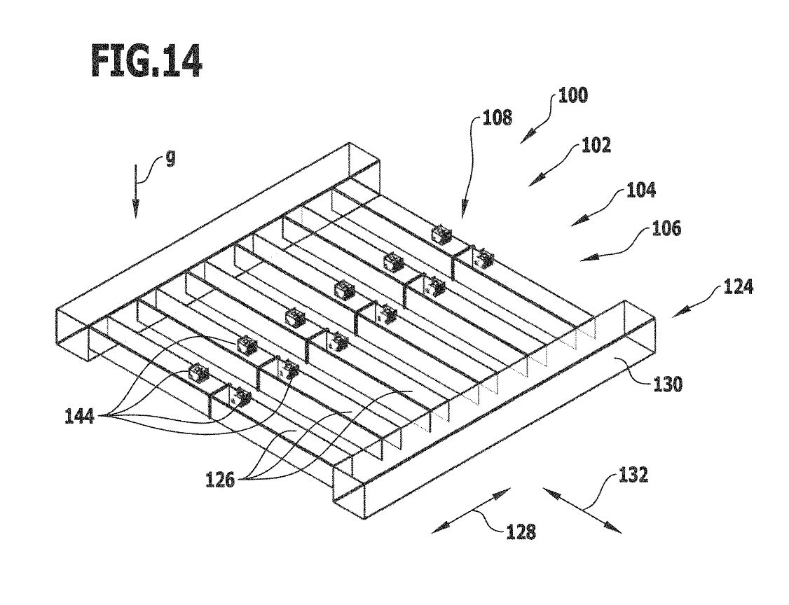

FIG. 14 shows a schematic perspective representation corresponding to FIG. 1 of an alternative embodiment of a floor unit where two rows of free-wheeling load-bearing rollers are provided;

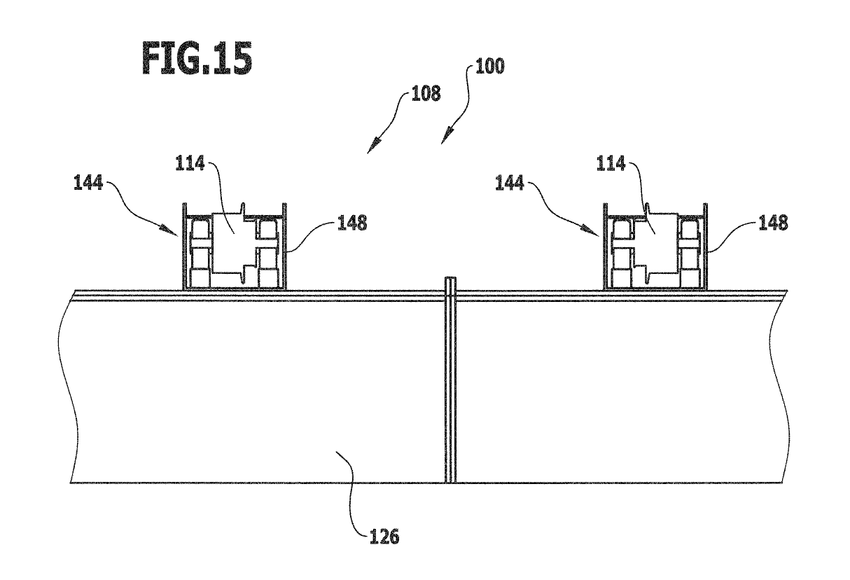

FIG. 15 shows a schematic sectional representation of a pair of load-bearing rollers according to the embodiment of the floor unit shown in FIG. 14;

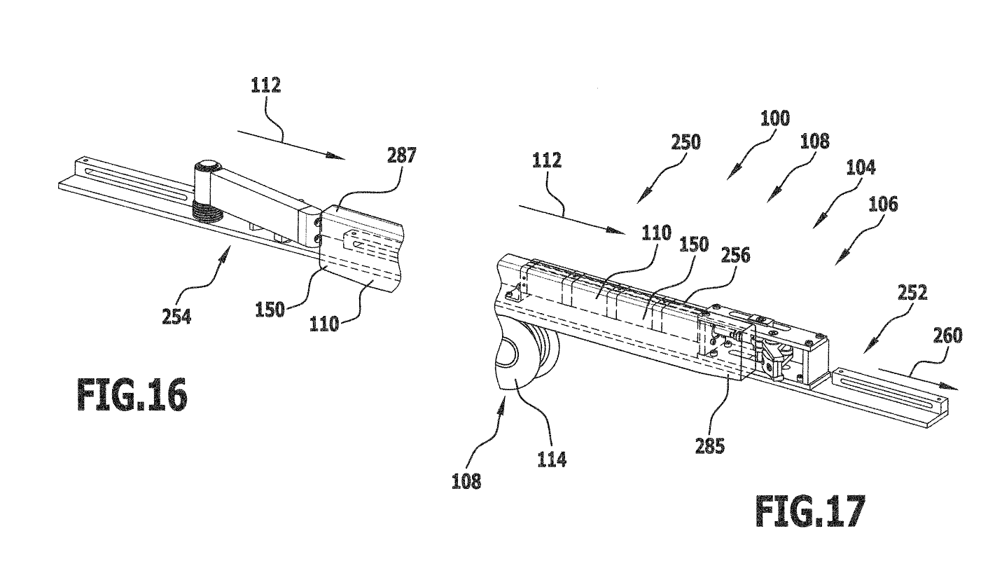

FIG. 16 shows a schematic perspective representation of a blocking device of a positioning device;

FIG. 17 shows a schematic perspective representation of a pushing device of the positioning device;

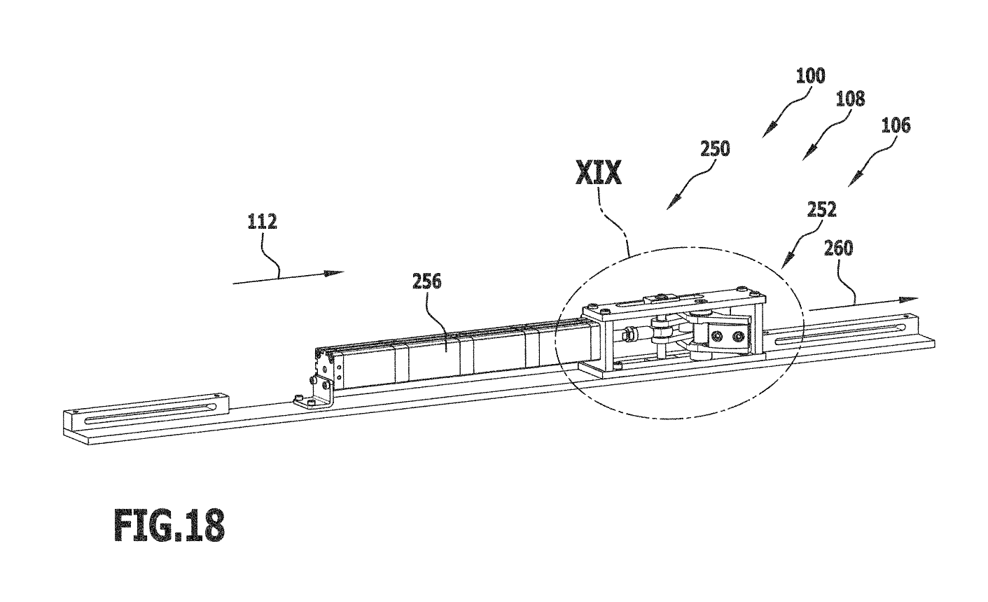

FIG. 18 shows a further schematic perspective representation of the pushing device of the positioning device;

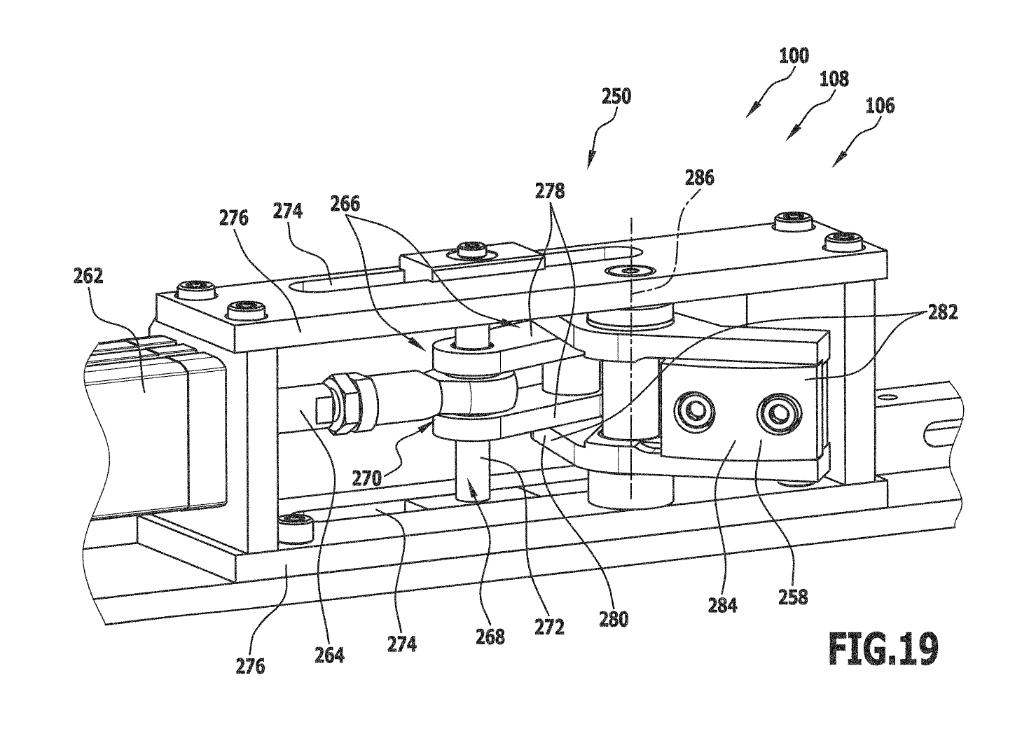

FIG. 19 shows an enlarged representation of the region XIX in FIG. 18;

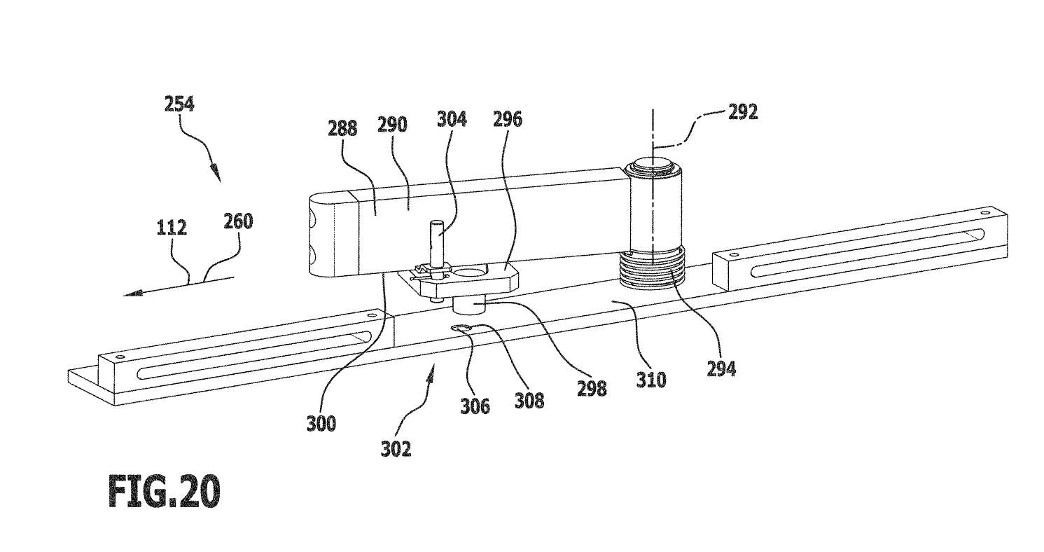

FIG. 20 shows an enlarged representation of the blocking device of the positioning device from FIG. 16; and

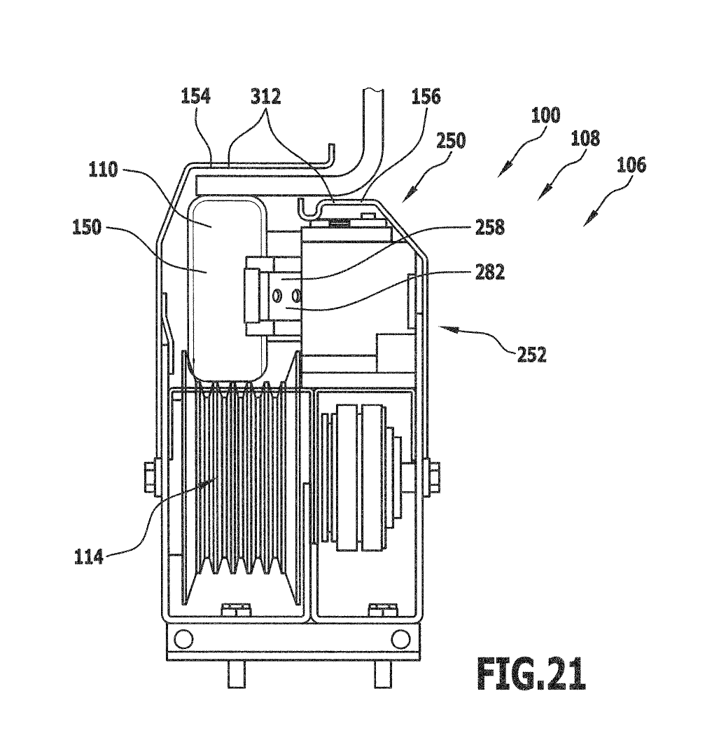

FIG. 21 shows a schematic vertical cross section through the pushing device of the positioning device in the mounted state of the same on a roller conveyor device.

Identical or functionally equivalent elements are provided with the same references in all the figures.

A coating and/or processing installation, which is shown for example in part in FIGS. 1 and 4 and given the reference 100 overall, is realized, for example, as a paint facility 102.

The coating and/or processing installation 100 includes a coating and/or processing chamber 104 in which workpieces (not shown) are able to be coated and/or processed.

The workpieces, in this case, can be coated or processed in particular in a coating and/or processing region 106 of the coating and/or processing chamber 104.

For conveying the workpieces through the coating and/or processing chamber 104, the coating and/or processing installation 100 includes a conveying device 108 which is realized, for example, as a roller conveyor conveying device 108.

The workpieces can be arranged on workpiece carriers 110 and conveyed by means of the conveying device 108 in a conveying direction 112 through the coating and/or processing chamber 104.

The conveying device 108 includes several pairs of load-bearing rollers 114, which are arranged one behind another in the conveying direction 112 and onto which the workpiece carriers 110 workpieces can be placed.

For driving the workpiece carriers 110, at least individual load-bearing rollers 114 can be driven by means of a drive device 116.

The drive device 116 includes for this purpose a motor 118, a force-transmitting drive element 120 and a coupling device 122 for coupling the drive element 120 with at least one load-bearing roller 114.

The conveying device 108 can be constructed, in principle, on an existing floor unit 124 of the coating and/or processing installation 100.

The drive device 116 is preferably incorporated at least in part and at least in portions in the floor unit 124 of the coating and/or processing installation 100.

It can be provided, in particular, that the floor unit 124 includes crossmembers 126 which are aligned transversely, in particular substantially perpendicularly, with respect to a longitudinal direction 128 of the coating and/or processing installation 100.

The longitudinal direction 128 of the coating and/or processing installation 100 extends in particular substantially parallel to the conveying direction 112 of the conveying device 108.

The crossmembers 126 of the floor unit 124 are arranged between two longitudinal members 130 of the floor unit 124 which extend parallel to the longitudinal direction 128 of the coating and/or processing installation 100.

The crossmembers 126 of the floor unit 124 are aligned substantially parallel to a horizontal transverse direction 132 of the coating and/or processing installation 100.

The longitudinal direction 128 and the transverse direction 132 of the coating and/or processing installation 100 are aligned substantially perpendicularly with respect to one another.

Openings 134, through which air is able to escape, in particular is able to be extracted, downward in the vertical direction out of the coating and/or processing chamber 104, are formed in the floor unit 124 between the two longitudinal members 130 and adjacent crossmembers 126.

In particular when the air guided through the floor unit 124 includes contaminants, the air passing through the floor unit 124 can result in unwanted contamination of the floor unit 124, the conveying device 108 and/or the drive device 116.

In order to protect, in particular, the drive device 116 from unwanted contamination and from impairment of the method of operation possibly resulting therefrom, the force-transmitting drive element 120 of the drive device 116 is arranged at least in portions in an interior 136 of a crossmember 126.

The force-transmitting drive element 120, in this case, is pre-mounted and/or prefabricated together with the crossmember 126 in particular prior to assembly of the entire coating and/or processing installation 100.

The floor unit 124, consequently, preferably includes a crossmember device 138 which includes a crossmember 126 and a force-transmitting drive element 120, the force-transmitting drive element 120 being arranged at least in portions in the interior 136 of the crossmember 126.

In the case of the first embodiment of the crossmember device 138 shown in FIG. 1, two load-bearing rollers 114 are arranged directly above the crossmember 126 in which the force-transmitting drive element 120 is arranged.

The further load-bearing rollers 114, which are arranged in front of and behind said load-bearing rollers 114 with reference to the conveying direction 112, are connected together by means of further coupling devices 122.

As can be seen in particular from FIG. 2, the coupling device 122 includes, for this purpose, in the region of the crossmember device 138 three coupling element receiving means 140 for receiving three coupling elements 142.

One of the coupling elements 142 serves for connecting the force-transmitting drive element 120 to the load-bearing roller 114 which is arranged directly above the crossmember 126 of the crossmember device 138.

The two further coupling element receiving means 140 and coupling elements 142 serve for coupling the load-bearing roller 114, which is arranged above the crossmember 126 of the crossmember device 138, with the further load-bearing rollers 114 which are arranged in front of and behind said load-bearing roller 114 with reference to the conveying direction 112.

Consequently a plurality of load-bearing rollers 114 is able to be driven by means of the drive device 116 in order to convey the workpiece carrier 110 and a workpiece arranged thereon in the conveying direction 112.

As can be seen in particular from FIG. 2, the load-bearing roller 114 is received in a load-bearing roller receiving means 144, in particular is mounted so as to be rotatable in the load-bearing roller receiving means 144.

A rotational axis 146 of the load-bearing roller 114, in this case, is aligned substantially horizontally and substantially perpendicularly with respect to the conveying direction 112.

The load-bearing roller receiving means 144 preferably includes a load-bearing roller housing 148 to protect the load-bearing roller 114.

The workpiece carrier 110 can be placed onto the load-bearing roller 114 by way of a runner 150 of the workpiece carrier 110.

In order to protect the load-bearing roller 114 and the runner 150 of the workpiece carrier 110 from contamination, a runner covering 152 is preferably provided.

The runner covering 152 is preferably realized in two parts and includes an upper covering 154 and a lower covering 156.

The upper covering 154 extends upward in the vertical direction g proceeding from the load-bearing roller housing 148 and engages around the runner 150 above the runner 150.

The lower covering 156 initially extends upward in the vertical direction g proceeding from the load-bearing roller housing 148 and then laterally in the horizontal direction as far as below the runner 150.

An end 158 of the lower covering 156 which is remote from the load-bearing roller housing 148 is preferably provided with a beading 160 in order to avoid unwanted ingress of dirt, in particular of liquid, in the region below the runner covering 152.

The upper covering 154 and/or the lower covering 156 preferably comprise in each case a plug-in connection 162, by means of which the upper covering 154 or the lower covering 156 are able to be placed onto the load-bearing roller housing 148.

As a result, the upper covering 154 and the lower covering 156 can easily be removed for cleaning and then easily arranged on the load-bearing roller housing 148 again.

A sensor device 164 is provided to detect whether a workpiece carrier 110 is arranged in the region of the load-bearing roller 114.

The sensor device 164 is, for example, an inductive proximity sensor.

The load-bearing roller receiving means 144 is secured to the crossmember 126 by means of a screw connection 166.

The drive element 120 of the drive device 116 is rotatably mounted in the interior 136 of the crossmember 126 by means of a bearing device 168.

The drive element 120 is realized in particular as a shaft 170, for example as a Cardan shaft.

The bearing device 168 is secured on the crossmember 126, in particular in the interior 136 of the crossmember 126, by means of a screw connection 166.

The drive element 120 is also provided with a coupling element receiving means 140. As a result, a torque can be transmitted from the drive element 120 to the load-bearing roller 114 by means of the coupling element 142.

The coupling element 142 is guided for this purpose through an opening 172 in the crossmember 126 and the load-bearing roller housing 148.

All the coupling elements 142 are preferably arranged inside the load-bearing roller receiving means 144, the load-bearing roller housing 148 and/or the crossmember 126 in order to prevent unwanted contamination of the coupling elements 142.

The embodiment of the coating and/or processing installation 100 shown in FIGS. 1 and 2 operates as follows:

a workpiece which is to be painted, for example, is arranged on the workpiece carrier 110.

By means of the conveying device 108 the workpiece together with the workpiece carrier 110 can be supplied to the coating and/or processing chamber 104.

To this end, the workpiece carrier 110 is placed by way of its runners 150 onto the load-bearing rollers 114 of the conveying device 108.

By driving the load-bearing rollers 114, the workpiece carrier 110 together with the workpiece arranged thereon can be conveyed in the conveying direction 112.

To drive the rollers 114, the force-transmitting drive element 120 of the drive device 116 is made to rotate by means of the motor 118 of the drive device 116.

Said rotational movement is transmitted by the force-transmitting drive element 120 to the load-bearing roller 114 by means of the coupling device 122.

As several load-bearing rollers 114 are coupled together by means of coupling elements 142, not just one load-bearing roller 114 is driven by means of the force-transmitting drive element 120. Rather, several load-bearing rollers 114 following one after another in the conveying direction 112 are driven at the same time in order to be able to move the workpiece carrier 110 in the conveying direction 112.

As can be seen in particular from FIG. 3, a spacer element 174 can be arranged between the load-bearing roller receiving means 144 and the crossmember 126 in order to enlarge a space between the floor unit 124 and the workpiece carrier 110 which is arranged on the load-bearing roller 114. As a result, a workpiece arranged on the workpiece carrier 110 can be arranged and conveyed at a greater distance from the ground.

A second embodiment of a crossmember device 138 can be formed as a result.

Apart from this, the second embodiment of the crossmember device 138 shown in FIG. 3, with regard to design and function, corresponds to the first embodiment of a crossmember device 138 shown in FIGS. 1 and 2 such that reference is made, in this respect, to the aforementioned description thereof.

A filter device 176 of the coating and/or processing installation 100 is shown in FIG. 4.

The filter device 176 is arranged below the floor unit 124 in the vertical direction g and serves for extracting and cleaning contaminated air that is arranged in the coating and/or processing chamber 104.

FIG. 4 additionally shows different embodiments of crossmember devices 138.

A third embodiment of a crossmember device 138 shown in FIG. 5 differs from the first embodiment shown in FIGS. 1 and 2 substantially in that the load-bearing rollers 114 are not arranged directly above the crossmember 126. Rather, carrier elements 178, which extend upward in the vertical direction g proceeding from the crossmember 126, are provided for the load-bearing rollers 114.

A shaft 182 for receiving two load-bearing rollers 114 is arranged on the upper end regions 180 of the carrier elements 178.

The load-bearing rollers 114 are consequently arranged at a spacing from the crossmember 126 in the case of the third embodiment shown in FIG. 5.

The load-bearing rollers 114 are connected together non-rotatably by means of the shaft 182.

The shaft 182, in this case, is provided with a coupling element receiving means 140 and is coupled with the drive element 120 by means of a coupling element 142 in order to be able to drive the load-bearing rollers 114 by means of the drive device 116.

Apart from this, the third embodiment of a crossmember device 138 shown in FIG. 5, with regard to design and function, agrees with the first embodiment shown in FIGS. 1 and 2 such that reference is made, in this respect, to the aforementioned description thereof.

A fourth embodiment of a crossmember device 138 shown in FIG. 6 differs from the first embodiment shown in FIGS. 1 and 2 substantially in that the load-bearing rollers 114 are incorporated directly in the crossmember 126.

The load-bearing roller receiving means 144 are arranged for this purpose at least in part in the interior 136 of the crossmember 126.

The load-bearing rollers 114, in this case, are arranged on the crossmember 126 such that they project upward out of the crossmember 126 at least in portions in the vertical direction g through an opening in the crossmember 126.

The workpiece carriers 110 can be placed onto the load-bearing rollers 114 in said portion of the same which projects out of the crossmember 126.

To drive the load-bearing rollers 114, they can either be arranged directly on the drive element 120 or can be coupled with the drive element 120 by means of a coupling device 122.

Apart from this, the fourth embodiment of a crossmember device 138 shown in FIG. 6, with regard to design and function, agrees with the first embodiment shown in FIGS. 1 and 2 such that reference is made, in this respect, to the aforementioned description thereof.

A fifth embodiment of a crossmember device 138 shown in FIG. 7 differs from the fourth embodiment shown in FIG. 6 substantially in that just one of the two load-bearing rollers 114 is driven.

Consequently, in the case of the fifth embodiment shown in FIG. 7, the force-transmitting drive element 120 of the drive device 116 extends simply into a region of one of the two load-bearing rollers 114.

Apart from this, the fifth embodiment of a crossmember device 138 shown in FIG. 7, with regard to design and function, agrees with the fourth embodiment shown in FIG. 6 such that reference is made, in this respect, to the aforementioned description thereof.

A sixth embodiment of a crossmember device 138 shown in FIG. 8 differs from the fourth embodiment shown in FIG. 6 substantially in that the crossmember 126 is not realized in a substantially linear manner.

Rather, the crossmember 126 in the case of the sixth embodiment of the crossmember device 138 shown in FIG. 8 includes three crossmember portions 186 which are arranged one behind the other in a longitudinal direction 184 of the crossmember 126.

The longitudinal direction 184 of the crossmember 126, in this case, is the direction in which the crossmember 126 comprises its greatest dimension.

The longitudinal direction 184 of the crossmember 126, in this case, is in particular parallel to the transverse direction 132 of the coating and/or processing installation 100.

A central crossmember portion 186m, which is arranged centrally with reference to the longitudinal direction 184 of the crossmember 126, is arranged between two outer crossmember portions 186a.

The central crossmember portion 186m is arranged offset upward in the vertical direction g in relation to the outer crossmember portions 186a which are arranged substantially along a common line.

To connect the central crossmember portion 186m to the outer crossmember portions 186a, crossmember portions 186q, which are aligned transversely, in particular substantially perpendicularly, with respect to the longitudinal direction 184 of the crossmember 126, are provided extending transversely thereto. The transversely extending crossmember portions 186q consequently extend in particular along a transverse direction 188 of the crossmember 126 which is aligned substantially perpendicularly to the longitudinal direction 184 of the crossmember 126.

The transverse direction 188 of the crossmember 126 can be aligned, in principle, horizontally or vertically. In the sixth embodiment of the crossmember device 138 shown in FIG. 8, the transverse direction 188 of the crossmember 126 is aligned vertically.

A substantially U-shaped structure 190 is formed by means of the transversely extending crossmember portions 186q and the central crossmember portion 186m.

The drive element 120 is arranged in one of the outer crossmember portions 186a.

A shaft 182 is arranged in the central crossmember portion 186m for receiving the two load-bearing rollers 114.

Both the drive element 120 and the shaft 182 extend in the longitudinal direction 184 of the crossmember 126 as far as into the region of one of the transversely extending crossmember portions 186q.

The shaft 182 is coupled with the drive element 120 for driving the load-bearing rollers 114 by means of a coupling element 142, for example a toothed belt or a chain, which extends inside the transversely extending crossmember portion 186q.

A rotational axis 191 of the drive element 120 is arranged parallel to the rotational axis 146 of the load-bearing roller 114, but is offset with respect to the same.

In addition, in the case of the sixth embodiment shown in FIG. 8, a sensor device 164 is provided for detecting a workpiece carrier 110.

Apart from this, the sixth embodiment of the crossmember device 138 shown in FIG. 8, with regard to design and function, agrees with the fourth embodiment shown in FIG. 6 such that reference is made, in this respect, to the aforementioned description thereof.

A seventh embodiment of a crossmember device 138 shown in FIG. 9 differs from the sixth embodiment shown in FIG. 8 substantially in that just one load-bearing roller 114 of the two load-bearing rollers 114 is driven. The shaft 182 consequently just extends from the region of the transversely extending crossmember portion 186q up to the nearest load-bearing roller 114.

The further load-bearing roller 114 is preferably realized as a free-wheeling load-bearing roller 114.

Apart from this, the seventh embodiment of the crossmember device 138 shown in FIG. 9, with regard to design and function, agrees with the sixth embodiment shown in FIG. 8 such that reference is made, in this respect, to the aforementioned description thereof.

An eighth embodiment of a crossmember device 138 shown in FIG. 10 differs from the sixth embodiment shown in FIG. 8 substantially in that the load-bearing rollers 114 are not incorporated in the central crossmember portion 186m.

Rather, the load-bearing rollers 114 are arranged outside the crossmember 126, namely on both sides of the crossmember 126, in front of and behind the central crossmember portion 186m with reference to the longitudinal direction 184 of the crossmember 126.

Apart from this, the eighth embodiment of a crossmember device 138 shown in FIG. 10, with regard to design and function, agrees with the sixth embodiment shown in FIG. 8, such that reference is made, in this respect, to the aforementioned description thereof.

A ninth embodiment of a crossmember device 138 shown in FIG. 11 differs from the eighth embodiment shown in FIG. 10 substantially in that just one of the load-bearing rollers 114 is driven. The further load-bearing roller 114 is a free-wheeling load-bearing roller 114.

Apart from this, the ninth embodiment of a crossmember device 138 shown in FIG. 11, with regard to design and function, agrees with the eighth embodiment shown in FIG. 10, such that reference is made, in this respect, to the aforementioned description thereof.

In the case of the embodiments of the crossmember device 138 shown in FIGS. 8 to 11, the central crossmember portion 186m is always offset upward in the vertical direction g.

In the case of further embodiments of crossmember devices 138 (not shown) which, apart from this, can correspond to the embodiments shown in FIGS. 8 to 11, it can be provided that the central crossmember portion 186m is offset downward in the vertical direction g.

A tenth embodiment of a crossmember device 138 shown in FIG. 12 differs from the third embodiment shown in FIG. 5 substantially in that a central support device 192 is provided instead of two carrier members 178.

Said support device 192 serves for receiving a shaft 182 for receiving the load-bearing rollers 114.

The coupling element 142 for driving the shaft 182 and consequently also the load-bearing rollers 114 extends inside the support device 192.

Apart from this, the tenth embodiment of the crossmember device 138 shown in FIG. 12, with regard to design and function, agrees with the third embodiment shown in FIG. 5 such that reference is made, in this respect, to the aforementioned description thereof.

An eleventh embodiment of a crossmember device 138 shown in FIG. 13 differs from the third embodiment shown in FIG. 5 substantially in that no common shaft 182 is provided on which the load-bearing rollers 114 are arranged.

Rather, each load-bearing roller 114 is arranged in each case on one of the carrier elements 178 by way of a separate shaft 182.

The load-bearing rollers 114, in this case, are additionally not arranged on outside surfaces of the carrier elements 178 which face away from one another, but on inside surfaces of the carrier elements 178 which face one another.

Apart from this, the eleventh embodiment of the crossmember device 138 shown in FIG. 13, with regard to design and function, agrees with the third embodiment shown in FIG. 5 such that reference is made, in this respect, to the aforementioned description thereof.

A schematic perspective representation corresponding to FIG. 1 of an alternative embodiment of a floor unit 124 can be seen in FIG. 14.

In the case of the floor unit 124 shown in FIG. 14, several pairs of free-wheeling load-bearing rollers 114 are provided. As can be seen in particular from the schematic sectional representation of two such load-bearing rollers 114 in FIG. 15, the load-bearing rollers 114, in this case, are arranged approximately according to the first embodiment shown in FIGS. 1 and 2 in a load-bearing roller receiving means 144 on the crossmember 126.

Such types of free-wheeling load-bearing rollers 114 can be used in particular in combination with driven load-bearing rollers 114.

In the case of further embodiments of crossmember devices 138, floor units 124 and/or coating and/or processing installations 100 (not shown), individual or several features of different embodiments of the above-described embodiments are able to be combined together.

As a result of the force-transmitting drive element 120 being arranged at least in portions in the interior 136 of the crossmember 126 in the case of all the embodiments, the drive element 120 is protected from unwanted contaminants. This means that a reliable operation of the conveying device 108 can be ensured.

It can be provided that the crossmember device 138, the floor unit 124 and/or the coating and/or processing installation 100 includes at least one positioning device 250.

By means of such a positioning device 250, it is possible, in particular, to position the workpiece carriers 110 along with the workpieces arranged thereon in a precise manner, in particular to stop them in a precise manner in a coating and/or processing chamber 104 of the coating and/or processing installation 100.

An embodiment of a positioning device 250 shown in FIGS. 16 to 21 includes a pushing device 252 and a blocking device 254.

The pushing device 252 includes a pressure cylinder device 256 by means of which a lever element 258 is movable, in particular is pushable or pivotable into a conveying path 260 of the workpiece carrier 110.

The pressure cylinder device 256 includes a pressure cylinder 262 and a piston rod 264 which can be pushed into or moved into the pressure cylinder 262 or pushed out or moved out of the pressure cylinder 262.

The piston rod 264 of the pressure cylinder device 256 is connected to the lever element 258 by means of two joint devices 266.

One joint device 266, in this case, serves as a direction-changing device 268 for changing a direction of movement of the piston rod 264 and, for this purpose, is arranged on one end 270 of the piston rod 264 which is remote from the pressure cylinder 262.

The direction-changing device 268 includes a cross rod 272 with which the piston rod 264 cooperates and which is movable along two guide slots 274 in two oppositely situated guide elements 276 of the pressure cylinder device 256 along the conveying direction 112 and in opposition to the conveying direction 112.

The cross rod 272 is pivotably connected to a connecting portion 280 of the lever element 258 by means of two transmitting elements 278. The further joint device 266 is consequently formed by means of the transmitting elements 278 and the lever element 258.

The lever element 258 includes two lever arms 282.

One lever arm 282 forms the connecting portion 280.

The further lever arm 282 forms a contact portion 284 of the lever element 258, by means of which the pushing device 252 is able to cooperate with the workpiece carrier 110, in particular is able to cooperate with a front end 285 of the workpiece carrier 110 with reference to the conveying direction 112.

By means of the pressure cylinder device 256, the lever element 258 is pivotable about a rotational axis 286 which is, in particular, vertically aligned.

The blocking device 254 includes a blocking element 288 which is realized, for example, as a locking pawl 290 (see FIG. 20).

The blocking element 288 is mounted so as to be pivotable about a, for example, vertically aligned rotational axis 292.

In particular, the blocking element 288 can be pivoted into the conveying path 260 of the workpiece carrier 110.

The blocking element 288 is provided with a spring 294.

The blocking element 288 is held by means of the spring 294 in a blocking position which is shown in FIG. 20.

Extensive pivoting into the conveying path 260 is prevented by means of a stopping element 296 which is arranged on the blocking element 288 as well as by means of a journal 298 of the blocking device 254 which corresponds hereto.

The stopping element 296 is, for example, a U-shaped element which is arranged, in particular welded, on an underside 300 of the blocking element 288, and is movable into engagement with the journal 298.

The blocking device 254 additionally includes a locking device 302, by means of which the blocking element 288 can be locked in a position (not shown) pivoted out of the conveying path 260.

The locking device 302 includes, in particular, a pin 304 which is arranged on the stopping element 296 and which, with the blocking element 288 in the position pivoted out of the conveying path 260, can be moved into engagement with an opening 306 or indentation 308 of the locking device 302, in particular an opening 306 or indentation 308 in a base plate 310.

As can be seen in particular in FIG. 21, the positioning device 250 is preferably arranged inside or at least below a covering device 312.

The positioning device 250 can be protected, in particular, from unwanted contamination by means of the covering device 312.

The covering device 312 preferably serves, in addition, for covering the workpiece carrier 110 at least in part.

At least one runner 150 of a workpiece carrier 110 which is realized as a skid can be covered, in particular, by means of the covering device 312 in order to protect the same from unwanted contamination.

The cleaning and maintenance requirement of the positioning device 250 and/or of the workpiece carrier 110 can preferably be reduced as a result.

The covering device 312 is preferably the runner covering 152 and includes, in particular, the upper covering 154 and the lower covering 156.

The positioning device 250 is arranged, in particular, in front of or behind a sensor device 164 (see FIG. 2) in an offset manner along the conveying direction 112.

The embodiment of the positioning device 250 shown in FIGS. 16 to 21 operates as follows:

with the conveying device 108 in operation, the workpiece carrier 110 along with the workpiece arranged thereon is moved along the conveying direction 112.

In order to stop the workpiece carrier 110 along with the workpiece arranged thereon in a desired position, in particular to secure it in a coating and/or processing region 106, the workpiece carrier 110 along with the workpiece arranged thereon is initially moved past the blocking device 254.

For this purpose, the blocking device 254 is preferably realized so as to block in one direction and the workpiece carrier 110 is able to move past the blocking device 254 in the conveying direction 112.

The blocking element 288, in this connection, is pivoted about the rotational axis 292 and at the same time is moved out of the conveying path 260.

As soon as the workpiece carrier 110 has moved past the blocking device 254, the blocking element 288 is pivoted back into the conveying path 260 again due to the action of the spring 294.

As a result of the development of the blocking element 288, in said state which is now obtained the workpiece carrier 110 is prevented from moving against the conveying direction 112.

Once the workpiece carrier 110 has moved past the blocking device 254 and the blocking device 254, in particular the blocking element 288, has moved back, for example, into the blocking position shown in FIG. 16, the front end 285 of a runner 150 of the workpiece carrier 110, with reference to the conveying direction 112, comes to abut against the contact portion 284 of the lever element 258 of the pushing device 252.

As a result, the workpiece carrier 110 is preferably brought to a standstill.

The workpiece carrier 110 is then positioned in a precise manner as a result of actuating the pressure cylinder device 256.

In this connection, the piston rod 264 is pushed or pressed out of the pressure cylinder 262 and, as a result, the lever element 258 is pivoted about the rotational axis 286.

The contact portion 284 is at the same time moved against the conveying direction 112 and pushes the workpiece carrier 110, which is abutting against the contact portion 284, back against the conveying direction 112 until it comes to abut against the blocking element 288 of the blocking device 254 by way of its rear end 287, with reference to the conveying direction 112.

The workpiece carrier 110 is then clamped between the blocking element 288 and the lever element 258, that is to say between the blocking device 254 and the pushing device 252, and is consequently locked in a desired position.

It is possible in particular to treat and/or process the workpiece arranged on the workpiece carrier 110 in said desired position.

The workpiece carrier 110 along with the workpiece arranged thereon can be secured in a predetermined position in particular in a coating and/or processing region 106 of the coating and/or processing installation 100 by means of the positioning device 250.

In order to be able to convey the workpiece carrier 110 along with the workpiece arranged thereon further along the conveying direction 112, in particular once a coating and/or processing operation has been carried out, the pressure cylinder device 256 is actuated once again. In this case, the piston rod 264 is retracted into the pressure cylinder 262 and, as a result, the lever element 258 is removed from the conveying path 260.

The workpiece carrier 110 is then able to be moved past the pushing device 252 in the conveying direction 112.

In the case of a further embodiment of a positioning device 250 (not shown), it can be provided that the piston rod 264 is connected directly to the connecting portion 280 of the lever element 258. The positioning device 250 is preferably able to be realized with a smaller number of components as a result of being developed in such a manner.

1. A crossmember device for a floor unit of a coating and/or processing chamber, including:
a crossmember which comprises an interior;
a force-transmitting drive element of a drive device for driving a load-bearing roller of a conveying device for conveying workpieces,
wherein the drive element is arranged at least in portions in the interior of the crossmember.

2. The crossmember device as claimed in claim 1, characterized in that the crossmember device includes a load-bearing roller receiving means for a load-bearing roller of the conveying device.

3. The crossmember device as claimed in claim 1, characterized in that the crossmember comprises at least two crossmember portions which are arranged one behind another with reference to a longitudinal direction of the crossmember and are arranged offset with respect to one another in a transverse direction of the crossmember which extends transversely with respect to the longitudinal direction.

4. The crossmember device as claimed in claim 1, characterized in that the crossmember comprises a crossmember portion which extends transversely with respect to a longitudinal direction of the crossmember.

5. The crossmember device as claimed in claim 4, characterized in that the crossmember includes two crossmember portions which extend transversely with respect to a longitudinal direction of the crossmember and one crossmember portion which is arranged offset with reference to a transverse direction which extends perpendicularly to the longitudinal direction, extends parallel to the longitudinal direction and is arranged between the two crossmember portions which extend transversely with respect to the longitudinal direction of the crossmember.

6. The crossmember device as claimed in claim 1, characterized in that the crossmember device includes a load-bearing roller of the conveying device and a coupling device for coupling the load-bearing roller with the drive element.

7. The crossmember device as claimed in claim 1, characterized in that the crossmember device includes a load-bearing roller of the conveying device, wherein a rotational axis of the load-bearing roller is arranged offset in relation to a rotational axis of the drive element in a transverse direction of the crossmember which extends perpendicularly to a longitudinal direction of the crossmember.

8. The crossmember device as claimed in claim 1, characterized in that the crossmember device includes at least two load-bearing rollers and/or at least two force-transmitting drive elements which are arranged at least in portions in the interior of the crossmember.

9. The crossmember device as claimed in claim 1, characterized in that the crossmember device includes a bearing device for the rotatable bearing arrangement of the force-transmitting drive element.

10. The crossmember device as claimed in claim 1, characterized in that the drive element.

11. The crossmember device as claimed in claim 1, characterized in that the crossmember device includes a pair of load-bearing rollers, wherein one or both of the load-bearing rollers of the pair of load-bearing rollers are connected to the drive element for driving the same.

12. The crossmember device as claimed in claim 1, characterized in that the crossmember device includes a pair of load-bearing rollers, wherein the two load-bearing rollers of the pair of load-bearing rollers are connected non-rotatably together by means of a common shaft.

13. The crossmember device as claimed in claim 1, characterized in that the conveying device includes a positioning device for positioning a workpiece carrier along with the one or the several workpieces arranged thereon, said positioning device and/or a blocking device.

14. The crossmember device as claimed in claim 13, characterized in that the workpiece carrier along with the one or the several workpieces arranged thereon is movable by means of the pushing device in a direction opposite to a conveying direction of the conveying device and/or in that the blocking device is realized so as to block in a single direction such that the workpiece carrier along with the one or the several workpieces arranged thereon can be moved past the blocking device in the conveying direction, but a movement of the workpiece carrier along with the one or the several workpieces arranged thereon in a direction opposite the conveying direction can be blocked.

15. The crossmember device as claimed in claim 13, characterized in that the pushing device and/or the blocking device is arranged at least in portions inside and/or below a covering device for covering supporting elements of the workpiece carrier.

16. A floor unit for a coating and/or processing chamber, including at least one crossmember device as claimed in claim 1.

17. The floor unit as claimed in claim 16, characterized in that the floor unit includes a crossmember device and in addition a crossmember on which a load-bearing roller of the conveying device is arranged, wherein the load-bearing roller is drivable by means of the drive element of the crossmember device.

18. A coating and/or processing installation for coating and/or processing workpieces, including:
a conveying device for conveying the workpieces through a coating and/or processing region of the coating and/or processing installation by means of workpiece carriers along a conveying direction of the conveying device, wherein the conveying device includes a load-bearing roller on which a workpiece carrier can be arranged for conveying the same;
a drive device for driving the load-bearing roller of the conveying device, wherein the drive device includes a force-transmitting drive element, wherein the force-transmitting drive element is arranged at least in portions in an interior of a crossmember of a floor unit of the coating and/or processing installation.
